(19) United States
(12) Patent Application Publication
(10) Pub. No.: US 2002/0025367 A1
(43) Pub. Date: Feb. 28, 2002

(54) Snack with improved flavor

(75) Inventors: Deborah Adamo Koehler, Middletown, OH (US); Thomas Northrup Asquith, Cincinnati, OH (US); Robert Leslie Swaine JR., Cincinnati, OH (US); Peter Yen-Chih Lin, Cincinnati, OH (US); James Earl Trout, West Chester, OH (US); Yen-Ping Chin Hsieh, Cincinnati, OH (US); Dennis Paul Kirkpatrick, Cincinnati, OH (US)

Correspondence Address: Melody A. Jones, The Procter & Gamble Co., 6071 Center Hill Avenue, Cincinnati, OH, 45224, US

(73) Assignee: The Procter & Gamble Co.

(21) Appl. No.: 09/824,609

(22) Filed: Apr. 2, 2001

Related U.S. Application Data
(60) Provisional application No. 60/197,740, filed on Apr. 18, 2000.

(51) Int. Cl. A21D 10/00; A23L 1/48

(52) U.S. Cl. 426/549; 426/808

(57) ABSTRACT

Full-fat, reduced-fat, low-fat, and fat-free snack food products with enhanced flavor. The enhanced flavor is obtained by incorporating flavor enhancers, particulates, Vitamin C, herbs & spices, or mixtures thereof into the dough.

### CROSS REFERENCE TO RELATED APPLICATION

This application claims the benefit of priority to U.S. Provisional Application Serial No. 60/197,740, filed Apr. 18, 2000, which is herein incorporated by reference.

### TECHNICAL FIELD

The present invention relates to full-fat, reduced-fat, low-fat, and fat-free farinaceous snacks. The snacks have a high degree of mouth-melt and an enhanced flavor and texture. The present invention further relates to a process for making the snacks.

### BACKGROUND OF THE INVENTION

Snacks such as potato crisps, corn chips and tortilla chips are particularly popular consumer snack products. In the case of farinaceous snacks, starch-based materials such as potato flakes are commonly reconstituted to form a dough sheet and then pieces are fabricated therefrom. These fabricated pieces are then immersed in a frying fat or oil. When immersed, the fabricated pieces absorb a substantial quantity of the frying fat or oil, typically on the order from about 25% to about 50% by weight of the resulting snack product.

In general, fabricated snacks contain equal or greater amounts of total flavor components, but the perceived flavor of fabricated snacks is less than that of conventional chips. Fabricated snacks and conventional snacks contain about equal amounts of total oil. Most of the oil in fabricated snacks, however, is bound into the chip matrix, whereas most of the oil in conventional chips is unbound. While not intending to be limited by theory, it is believed that flavor perception is related to the release of flavor from unbound oil. Thus, fabricated snacks have a lower perceived flavor.

Fabricated snacks prepared with non-digestible fats have even less perceived flavor than those prepared with digestible fats. The flavor is “suppressed” by the non-digestible fat compositions, which coat the mouth and suppress the flavor display of the snack. Flavor release is also suppressed by oils with high viscosity (such non-digestible fats).

The decreased flavor characteristic of snacks fried in compositions comprising non-digestible fats are believed to be caused by solids crystallizing in the non-digestible fat that is absorbed by the snack during frying. During frying, the non-digestible fat is absorbed by the snack in a liquefied state. As the snack cools, crystallization of the intermediate-melting and low-melting fats occurs, and the solids formed as a result of crystallization alter the organoleptical properties of the snack (e.g., crispness, waxiness impression and mouthmelt). Because these solids are needed in the non-digestible fat composition to prevent passive oil loss, formulation flexibility with regard to the non-digestible frying fat is limited to increasing levels of triglyceride fat, thus offsetting the benefit of calorie reduction.

In an effort to overcome the additional loss of flavor associated with non-digestible fats, mixtures of digestible and non-digestible fats have been proposed. Frying in blends of digestible and non-digestible fat has been shown to increase the flavor perception somewhat, but is still less than desirable.

Although seasonings can be topically applied to snack products for increased flavor, the flavor display which results through topical means is less than desirable. Topical seasonings provide an immediate, intense flavor display upon initial mastication, then the flavor intensity sharply decreases.

Thus, it would be desirable to be able to produce reduced fat, low fat, and fat free snacks having enhanced flavor. It would also be desirable to provide full-fat snacks with enhanced flavor and improved texture. It would also be desirable to provide snacks with a sustained flavor display throughout mastication.

Accordingly, it is an object of this invention to provide snack products having enhanced flavor. It is also an object of this invention to provide snacks with sustained flavor display throughout mastication.

These and other objects of the invention will become apparent hereafter.

### SUMMARY OF THE INVENTION

The present invention provides snacks with a sustained, enhanced flavor display. These snacks are prepared from doughs comprising from about 0.1 ppt to about 6%, preferably from about 0.01% to about 2%, and more preferably from about 0.05% to about 0.4% in the dough. The flavor enhancer can be selected from flavor enhancing compounds such as amino acids, peptides, proteins, vitamins, reducing sugars, nucleotide flavor enhancers, carbohydrate decomposition products, extractives of herbs and spices, oleoresins and mixtures thereof

Preferably, the snack dough also comprises from about 0.1% to about 10% particulates to add visual appeal to the snack. The preferred particulates are sized such that they can pass through a U.S. mesh # of from about 5 to about 50, preferably from about 14 to about 20. The most preferred particulates comprise less than about 60%, more preferably less than about 20%, and most preferably less than about 10% fat, and a Water Activity of less than about 0.8, preferably from about 0.1 to about 0.5. It has been found that particulates having these properties can be directly added to the snack doughs without adversely affecting the snack making process (i.e. the dough sheet does not tear during sheeting and the particulates do not burn during drying or frying). Particulates can have up to about 100%, preferably up to about 75%, and more preferably from about 20% to about 40% visual surface coverage of the surface area of the finished snack.

Additionally, Vitamin C can be added to the dough at a level of from about 0.01% to about 0.4%, preferably from about 0.05% to about 0.2%, and more preferably from about 0.1% to about 0.15%. In addition to nutritional benefits, Vitamin C can also function as a flavor potentiator and an antioxidant.

For extra flavor, herbs and spices can also be added to the snack dough at a level of up to about 8%, preferably up to 5%, and more preferably from about 0.1% to about 3%.

The snack can be fried in non-digestible fat, digestible fat, or mixtures thereof. Preferably, the snack is fried in a mixture of non-digestible and digestible fat comprising from about 50% to about 90% non-digestible fat and from about 10% to about 50% digestible fat, and more preferably in a mixture of non-digestible and digestible fat comprising from about 70% to about 85% non-digestible fat and from about 15% to about 30% digestible fat.

### DETAILED DESCRIPTION

A. DEFINITIONS

As used herein, “ppt” means parts per trillion (1 part per 1×10¹²).

As used herein “sheetable dough” is a dough capable of being placed on a smooth surface and rolled to the desired final thickness without tearing or forming holes. Sheetable dough can also include dough that is capable of being formed into a sheet through an extrusion process.

As used herein, “flavor enhancer” refers to a substance which has little of the desired end flavor itself, but when added to food, has the property of enhancing or intensifying the flavor of the food. Flavor enhancers include, but are not limited to, flavor precursors, flavor potentiators, reactive flavors, reaction flavors, and agents that suppress or mask undesirable flavors. Flavor enhancers can also include extractives and oleoresins of herbs and spices. Flavor enhancers may be in liquid or dry form; for instance, they may be encapsulated, agglomerated, or plated.

As used herein “starch-based materials” refer to naturally occuring, high polymeric carbohydrates composed of glucopyranose units, in either natural, dehydrated (e.g., flakes, granules, meal) or flour form. The starch-based materials include, but are not limited to, potato flour, potato granules, potato flanules, potato flakes, corn flour, masa corn flour, corn grits, corn meal, rice flour, buckwheat flour, oat flour, bean flour, barley flour, tapioca, as well as modified starches, native starches, and dehydrated starches, starches derived from tubers, legumes and grain, for example cornstarch, wheat starch, rice starch, waxy corn starch, oat starch, cavassa starch, waxy barley, waxy rice starch, glutinous rice starch, sweet rice starch, amioca, potato starch, tapioca starch, and mixtures thereof.

As used herein, “modified starch” refers to starch that has been physically or chemically altered to improve its functional characteristics. Suitable modified starches include, but are not limited to, pregelatinized starches, low viscosity starches (e.g., dextrins, acid-modified starches, oxidized starches, enzyme modified starches), stabilized starches (e.g., starch esters, starch ethers), cross-linked starches, starch sugars (e.g. glucose syrup, dextrose, isoglucose) and starches that have received a combination of treatments (e.g., cross-linking and gelatinization) and mixtures thereof.

As used herein, the term “added water” refers to water which has been added to the dry dough ingredients. Water which is inherently present in the dry dough ingredients, such as in the case of the sources of flour and starches, is not included in the added water.

As used herein, the term “emulsifier” refers to an emulsifier which has been added to the dough ingredients. Emulsifiers which are inherently present in the dough ingredients, such as in the case of the potato flakes, are not included in the term emulsifier.

All percentages are by weight unless otherwise specified.

The terms “fat” and “oil” are used interchangeably herein unless otherwise specified. The terms “fat” or “oil” refer to edible fatty substances in a general sense, including natural or synthetic fats and oils consisting essentially of triglycerides, such as, for example soybean oil, corn oil, cottonseed oil, sunflower oil, palm oil, coconut oil, canola oil, fish oil, lard and tallow, which may have been partially or completely hydrogenated or modified otherwise, as well as non-toxic fatty materials having properties similar to triglycerides, herein referred to as non-digestible fats, which materials may be partially or fully indigestible. Reduced calorie fats and edible non-digestible fats, oils or fat substitutes are also included in the term.

The term “non-digestible fat” refers to those edible fatty materials that are partially or totally indigestible, e.g., polyol fatty acid polyesters, such as OLEAN™.

By “polyol” is meant a polyhydric alcohol containing at least 4, preferably from 4 to 11 hydroxyl groups. Polyols include sugars (i.e., monosaccharides, disaccharides, and trisaccharides), sugar alcohols, other sugar derivatives (i.e., alkyl glucosides), polyglycerols such as diglycerol and triglycerol, pentaerythritol, sugar ethers such as sorbitan and polyvinyl alcohols. Specific examples of suitable sugars, sugar alcohols and sugar derivatives include xylose, arabinose, ribose, xylitol, erythritol, glucose, methyl glucoside, mannose, galactose, fructose, sorbitol, maltose, lactose, sucrose, raffinose, and maltotriose.

By “polyol fatty acid polyester” is meant a polyol having at least 4 fatty acid ester groups. Polyol fatty acid esters that contain 3 or less fatty acid ester groups are generally digested in, and the products of digestion are absorbed from, the intestinal tract much in the manner of ordinary triglyceride fats or oils, whereas those polyol fatty acid esters containing 4 or more fatty acid ester groups are substantially non-digestible and consequently non-absorbable by the human body. It is not necessary that all of the hydroxyl groups of the polyol be esterified, but it is preferable that disaccharide molecules contain no more than 3 unesterified hydroxyl groups for the purpose of being non-digestible. Typically, substantially all, e.g., at least about 85%, of the hydroxyl groups of the polyol are esterified. In the case of sucrose polyesters, typically from about 7 to 8 of the hydroxyl groups of the polyol are esterified.

The polyol fatty acid esters typically contain fatty acid radicals typically having at least 4 carbon atoms and up to 26 carbon atoms. These fatty acid radicals can be derived from naturally occurring or synthetic fatty acids. The fatty acid radicals can be saturated or unsaturated, including positional or geometric isomers, e.g., cis- or trans- isomers, and can be the same for all ester groups, or can be mixtures of different fatty acids.

Liquid non-digestible oils can also be used in the practice of the present invention. Liquid non-digestible oils have a complete melting point below about 37° C. include liquid polyol fatty acid polyesters (see Jandacek; U.S. Pat. No. 4,005,195; issued Jan. 25, 1977); liquid esters of tricarballylic acids (see Hamm; U.S. Pat. No. 4,508,746; issued Apr. 2, 1985); liquid diesters of dicarboxylic acids such as derivatives of malonic and succinic acid (see Fulcher; U.S. Pat. No. 4,582,927; issued Apr. 15, 1986); liquid triglycerides of alpha-branched chain carboxylic acids (see Whyte; U.S. Pat. No. 3,579,548; issued May 18, 1971); liquid ethers and ether esters containing the neopentyl moiety (see Minich; U.S. Pat. No. 2,962,419; issued Nov. 29, 1960); liquid fatty polyethers of polyglycerol (See Hunter et al; U.S. Pat. No. 3,932,532; issued Jan. 13, 1976); liquid alkyl glycoside fatty acid polyesters (see Meyer et al; U.S. Pat. No. 4,840,815; issued Jun. 20, 1989); liquid polyesters of two ether linked hydroxypolycarboxylic acids (e.g., citric or isocitric acid) (see Huhn et al; U.S. Pat. No. 4,888,195; issued Dec. 19, 1988); various liquid esterfied alkoxylated polyols including liquid esters of epoxide-extended polyols such as liquid esterified propoxylated glycerins (see White et al; U.S. Pat. No. 4,861,613; issued Aug. 29, 1989; Cooper et al; U.S. Pat. No. 5,399,729; issued Mar. 21, 1995; Mazurek; U.S. Pat. No. 5,589,217; issued Dec. 31, 1996; and Mazurek; U.S. Pat. No. 5,597,605; issued Jan. 28, 1997); liquid esterified ethoxylated sugar and sugar alcohol esters (see Ennis et al; U.S. Pat. No. 5,077,073); liquid esterified ethoxylated alkyl glycosides (see Ennis et al; U.S. Pat. No. 5,059,443, issued Oct. 22, 1991); liquid esterified alkoxylated polysaccharides (see Cooper; U.S. Pat. No. 5,273,772; issued Dec. 28, 1993); liquid linked esterified alkoxylated polyols (see Ferenz; U.S. Pat. No. 5,427,815; issued Jun. 27, 1995 and Ferenz et al; U.S. Pat. No. 5,374,446; issued Dec. 20, 1994); liquid esterfied polyoxyalkylene block copolymers (see Cooper; U.S. Pat. No. 5,308,634; issued May 3, 1994); liquid esterified polyethers containing ring-opened oxolane units (see Cooper; U.S. Pat. No. 5,389,392; issued Feb. 14, 1995); liquid alkoxylated polyglycerol polyesters (see Harris; U.S. Pat. No. 5,399,371; issued Mar. 21, 1995); liquid partially esterified polysaccharides (see White; U.S. Pat. No. 4,959,466; issued Sep. 25, 1990); as well as liquid polydimethyl siloxanes (e.g., Fluid Silicones available from Dow Coming). All of the foregoing patents relating to the liquid nondigestible oil component are incorporated herein by reference. Solid non-digestible fats or other solid materials can be added to the liquid non-digestible oils to prevent passive oil loss. Particularly preferred non-digestible fat compositions include those described in U.S. Pat. No. 5,490,995 issued to Corrigan, 1996, U.S. Pat. No. 5,480,667 issued to Corrigan et al, 1996, U.S. Pat. No. 5,451,416 issued to Johnston et al, 1995 and U.S. Pat. No. 5,422,131 issued to Elsen et al, 1995. U.S. Pat. No. 5,419,925 issued to Seiden et al, 1995 describes mixtures of reduced calorie triglycerides and polyol polyesters that can be used herein but provides more digestible fat than is typically preferred.

The preferred non-digestible fats are fatty materials having properties similar to triglycerides such as sucrose polyesters. OLEAN™, a preferred non-digestible fat, is made by The Procter and Gamble Company. These preferred non-digestible fat are described in Young; et al., U.S. Pat. No. 5,085,884, issued Feb. 4, 1992, and U.S. Pat. No. 5,422,131, issued Jun. 6, 1995 to Elsen et al.

B. INGREDIENTS

1. Flavor Enhancers

Usually, flavor improvements in fried sheeted dough products are achieved by topically applying flavors to the snack post-frying. However, this mechanism typically can result in a less preferred flavor display, since the topically applied materials are difficult to consistently apply and do not always uniformly adhere to the snack. In addition, topically applied flavorants are messy and thus can make eating the snack difficult.

Adding flavor enhancers to the dough achieves a more consistent flavor distribution and display throughout the snack, because the flavor is developed via in-situ reactions enabled by the heat of the frying (or other cooking) process. Thus, the snack can deliver longer lasting flavors during consumption.

Flavor enhancers can be included at a level of from about 0.1 ppt to about 6%, preferably from about 0.01% to about 2%, and more preferably from about 0.05% to about 0.4% in the dough.

This “in-dough” flavor enhances the flavor of the finished product, and provides flavor from within the product. The snacks have a sustained flavor display throughout mastication. The improved flavor benefit is achieved by the addition of an excess of flavor enhancers to the raw dough blend prior to frying.

The enhancers can include sources of sulfur commonly found in foods from free amino acids, peptides and proteins (i.e. methionine, methionine sulfoxide, cysteine, cysine, alanine, glycine, lysine, proline, glutamic acid, methyl cysteine, methylcysteine sulfoxide, cysteine sulfoxide, glutathione, homocysteine and hydrolysates), vitamins (i.e. thiamine, panothenic acid) and reducing sugars (i.e. arabinose, glucose, ribose, xylose, mannose, fructose, xylose, ribose-5-phosphate, etc.). Nucleotide flavor enhancers like 5′-IMP and 5′-GMP can also be used, as can carbohydrate decomposition products such as methyl glyoxal and Furaneol™. Flavor enhancers can also include extractives and oleoresins of herbs and spices.

A preferred mix of flavor enhancers, which creates an enhanced fried potato flavor, is Firmenich #56.708/BH.

The enhancers are typically added directly to the raw dough blend prior to frying. These enhancers may be fully, partially, or non-reacted prior to addition to the dough. The added flavor enhancers supplement the naturally present flavor precursors. These additional enhancers are available to react (i.e via Maillard and non-enzymatic reactions) in the heat of the frying process to increase the total flavor amount to a more consumer meaningful and desirable level.

Additionally, flavor enhancers can be sprayed onto the hot product immediately after frying.

Types of flavor compounds which can increase from addition of the enhancers include pyrazines, pyridines, furans, thiophenes, pyrroles, thiols, thio-substituted pyridines, disulfides, thiosulfonates. The amounts and ratios of the products will vary depending upon the precursor mix, partial reactions of the precursors, process conditions to form the dough, cooking conditions to form the snack and oil blend for the frying.

2. Particulates

The addition of visual particulates can improve the visual appeal of the snack. Furthermore, incorporation of flavored particulates can provide a longer lasting flavor display during consumption. The addition of flavored particulates to the dough can also reduce or eliminate the need to add messy topical flavorings or seaonings. In addition, particulates which are functional, such as fibers, vitamins, or minerals, also enhance the health benefits of the snack.

Particulates can be added to the dough at a level of from about 0.1% to about 10%. The particulates are sized such that they can pass through a U.S. mesh # of from about 5 to about 50, preferably from about 14 to about 20. The most preferred particulates comprise less than about 60%, more preferably less than about 20%, and most preferably less than about 10% fat, and a Water Activity of less than about 0.8, preferably from about 0.1 to about 0.5.

Particulates can be added in any suitable form, such as in powder/granular form or in a slurry.

It has been found that the particulates of the present invention can be directly added to the snack doughs without adversely affecting the snack making process. When particulates of the present invention are used, the dough sheet does not tear and the particulates do not burn during drying or frying.

In the finished snack, the particulates can have a visual surface coverage of up to about 100%, preferably up to about 75%, more preferably up to about 50%, and more preferably from about 20% to about 40%, of the surface area of the snack.

Suitable particulates for use herein include, but are not limited to, potato skins, cereal bran (i.e. wheat, rice, or corn bran), spices, herbs, dried vegetables, confectionery components, starch glass particulates, nuts, seeds, and mixtures thereof. Specifically, other components can include bacon bits, sun dried tomatoes, dried fruits, dried green or red peppers, encapsulated and/or agglomerated flavors and/or colors, and any other suitable material.

Other types of particulates which are contemplated by the present invention include those that fizzle upon contact with moisture (saliva), those that will expand or pop upon heating, encapsulated particulates, particulates that are carriers of nutrients, particulates that deliver a burst of flavor, particulates that are broken or ground from other foods (pretzels, cereals, potato chips etc.), and frozen or dried particulates of unprocessed foods (apple chips, shredded potato hashbrown).

Particulates can also be topically applied to the dough sheet after sheeting and then enbedded through the application of pressure. Alternatively, a sticky substance, such as a starch or sugar solution or oil, can be applied to the dough sheet before particulate application.

3. Vitamin C

Vitamin C can be added to the doughs at a level of from about 0.01% to about 0.4%, preferably at a level of from about 0.05% to about 0.2%, more preferably at a level of from about 0.1% to about 0.15%. Preferably the addition of vitamin C to the dough is such that the final snack comprises from about 2 mg to about 120 mg, preferably from about 15 mg to about 60 mg, of Vitamin C per one ounce serving of the snack.

Vitamin C can also function as a reducing sugar and therefore react to form flavor. In addition to providing nutritional benefits to the snack, Vitamin C can also function as a flavor potentiator and as an antioxidant.

4. Herbs & Spices

Herbs and spices can be included in the dough at a level of up to about 8%, preferably up to 5%, more preferably from about 0.1% to about 3%. Spices which may be added include, but are not limited to, dehydrated vegetables, onion, garlic, tarragon, dill, marjoram, sage, basil, thyme, oregano, cumin, cilantro, chili powder, corriander, mustard, mustard seed, celery, carrots, lemon peel, orange peel, savory, rosemary, paprika, cinnamon, curry, cardamon, fennel seeds, bay, laurel, cloves, fennugrek, parsley, turmeric, chives, scallions, leeks, shallots, nutmeg, mace, allspice, cocoa powder, cayenne pepper, bell pepper, and hot peppers, as well as dried fruits. In addition, extractives and oleoresins of herbs and spices may be used.

5. Starch-based Materials

The doughs of the present invention comprise starch-based materials. The doughs of the present invention can comprise from about 50% to about 70%, preferably from about 55% to about 65%, and more preferably about 60% of a starch-based material. The starch-based material can comprise from about 25 to 100% potato flakes with the balance (i.e., from 0 to about 75%) being other starch-containing ingredients such as potato flour, potato flanules, potato granules, corn flour, masa corn flour, corn grits, corn meal, rice flour, buckwheat flour, rice flour, oat flour, bean flour, and barley flour, as well as modified starches, native starches, and dehydrated starches, starches derived from tubers, legumes and grain, for example cornstarch, wheat starch, rice starch, waxy corn starch, oat starch, cavassa starch, waxy barley, waxy rice starch, glutinous rice starch, rice starch, sweet rice starch, amioca, potato starch, tapioca starch, and mixtures thereof. Suitable starch-based materials disclosed in WO 99/33357, published Jul. 8, 1999 by Gizaw et al., may be used.

The starch-based material preferably comprises from about 40% to about 90%, more preferably from about 50% to about 80%, and even more preferably about 60% to about 70%, potato flakes and from about 10% to about 60%, preferably from about 20% to about 50%, and more preferably from about 30% to about 40%, of these other starch-containing ingredients.

The starch-based materials preferably comprise a high amylopectin flour or starch (preferably at least about 40% amylopectin) selected from the group consisting of waxy corn, waxy barley, waxy rice, glutinous rice, sweet rice, and mixtures thereof. When a high amylopectin flour or starch is used it is preferably present at a level of from about 1% to about 15%, preferably from about 2% to about 10%, and more preferably from about 3% to about 6%, by weight of the starch-based materials. Particularly preferred high amylopectin starches are available from National Starch and Chemical Corporation, Bridgewater, N.J. and are sold under the trades name of Cereal Crisp™ and Hylon V™ (50% amylose) and Hylon VII™ (70% amylose).

6. Modified Starch

The preferred doughs of the present invention can include modified starch. When calculating the level of modified starch according to the present invention, modified starch (e.g., gelatinized starch) that is inherent in potato flakes, potato flanules, potato granules, and flours is not included. (The level of modified starch is that which is added over and above that level inherently present in the potato flakes, potato flanules, potato granules, and flours.)

Preferably, at least about 0.2% modified starch selected from the group consisting of pregelatinized starches, cross-linked starches, acid modified starches, and mixtures thereof are included to change the texture (i.e. increase the crispness) of the snack. Preferably, a level of from about 0.2% to about 15%, more preferably from about 1% to about 10%, and even more preferably from about 3% to about 7%, modified starch is used. Particularly preferred modified starches are available from National Starch and Chemical Corporation, Bridgewater, N.J. and are sold under the trade names of N-Lite™ (pregelatinized-cross-linked starch, Ultrasperse -A™ (pregelatinized, waxy corn), N-Creamer™ 46 and Corn PCPF400™ (partially pre-cooked corn meal). Suitable modified starches disclosed in WO 99/33357, published Jul. 8, 1999 by Gizaw et al., may be used.

Hydrolyzed starch is an especially preferred modified starch that can be included in the doughs of the present invention. Hydrolyzed starches are typically included in the dough compositions in an amount of at least about 1%, with a usual range of from about 1% to about 15%, preferably from about 3% to about 12%. Suitable hydrolyzed starches for inclusion in the dough include maltodextrins and corn syrup solids. The hydrolyzed starches for inclusion in the dough have Dextrose Equivalent (D.E.) values of from about 5 to about 30, preferably from about 10 to about 20. Maltrin™ M050, M100, M150, M180, M200, and M250 (available from Grain Processing Corporation, Iowa) are preferred maltodextrins. The D.E. value is a measure of the reducing equivalence of the hydrolyzed starch referenced to dextrose and is expressed as a percentage (on a dry basis). The higher the D.E. value, the higher the dextrose equivalence of the starch.

7. Water

The dough compositions of the present invention comprise from about 20% to about 50% added water, preferably from about 22% to about 40%, and more preferably from about 24% to about 35%, added water. The level of water in flours and starches is usually from about 3% to about 12%. However, if other ingredients, such as maltodextrin or corn syrup solids, are added as a solution or syrup, the water in the syrup or solution is included as “added water”. The amount of added water also includes any water used to dissolve or disperse ingredients and includes water present in corn syrups, etc.

8. Emulsifiers

An ingredient that can optionally be added to the dough to aid in its processability is an emulsifier. Typically, emulsifiers are added to the dough in an amount of from about 0.02% to about 6%, preferably from about 0.1% to about 5%, and more preferably from about 2% to about 4%.

An emulsifier is preferably added to the dough composition prior to sheeting the dough. The emulsifier can be dissolved in a fat or in a polyol fatty acid polyester such as Olean™, available from The Procter and Gamble Company. Suitable emulsifiers include lecithin, mono- and diglycerides, diacetyl tartaric acid esters and propylene glycol mono- and diesters and polyglycerol. Polyglycerol emulsifiers such as monoesters of polyglycerols, preferably hexapolyglycerols, can be used. Particularly preferred monoglycerides are sold under the trade names of Dimodan® available from Danisco, New Century, Kan. and DMG 70, available from Archer Daniels Midland Company, Decatur, Ill.

C. DOUGH PREPARATION

The dough of the present invention can be prepared by any suitable method, preferably by sheeting. The dough compositions of the present invention can be prepared by thoroughly mixing together the flakes, granules, modified starches, other starches, optionally an emulsifier, and optionally other dry components. Typically, a water pre-blend of maltodextrin, Vitamin C, and other optional ingredients are mixed separately. The water pre-blend is then added to the potato flour and/or granules mixture and emulsifier blend and mixed to form a loose, dry dough. The flavor enhancers and particulates can be pre-blended into the emulsifier, the water pre-blend, or directly into the flour mix. Preferred devices for mixing together the dough ingredients are conventional mixers. Hobart® mixers (such as Model #VCM-25) can be used for batch operations and Turbulizer® mixers can be used for continuous mixing operations. However, extruders can also be used to mix the dough and to form the sheets or shaped pieces.

Once prepared, the dough can be formed into a relatively flat, thin sheet. Any method suitable for forming such sheets from starch-based doughs can be used. For example, the sheet can be rolled out between two counter rotating cylindrical rollers to obtain a uniform, relatively thin sheet of dough material. Any conventional sheeting, milling and gauging equipment can be used.

Dough compositions of the present invention are usually formed into a sheet having a thickness of from about 0.01 to about 0.1 inches (from about 0.025 to about 0.25 cm), and preferably to a thickness of from about 0.015 to about 0.05 inches (from about 0.038 to about 0.127 cm), and most preferably from about 0.018 to about 0.03 inches (0.046 to 0.076 cm). For rippled (wavy shaped) chips, the preferred thickness is about 0.03 inches (0.076 cm) to about 0.04 inches (0.102 cm). The dough sheet is then formed into snack pieces of a predetermined size and shape. The snack pieces can be formed using any suitable stamping or cutting equipment. The snack pieces can be formed into a variety of shapes. For example, the snack pieces can be in the shape of ovals, squares, circles, a bowtie, a star wheel, or a pin wheel. The pieces can be scored to make rippled chips as described in published PCT application WO 95/07610, Dawes et al., Jan. 25, 1996, which is incorporated by reference.

After the snack pieces are formed, they are cooked until crisp. The snack pieces can be cooked by frying, by partially frying and then baking, by partially baking then frying, by baking, or by any other suitable method. The snack pieces can be fried in a fat composition comprising digestible fat, non-digestible fat, or mixtures thereof.

It is preferred to fry the snack pieces at temperatures of from about 275° F. (135° C.) to about 420° F. (215° C.), preferably from about 300° F. (149° C.) to about 410° F. (210° C.), and more preferably from about 350° F. (177° C.) to about 400° F. (204° C.) for a time sufficient to form a product having about 6% or less moisture, preferably from about 0.5% to about 4%, and more preferably from about 1% to about 2% moisture. The exact frying time is controlled by the temperature of the frying fat and the starting water content of the dough, which can be easily determined by one skilled in the art.

Preferably, the snack pieces are fried in oil using a continuous frying method and are constrained during frying. This constrained frying method and apparatus is described in U.S. Pat. No. 3,626,466 (Liepa, 1971). The shaped, constrained pieces are passed through the frying medium until they are fried to a crisp state with a final moisture content of from about 0.5% to about 4% water, preferably 1% to 2%.

Any other method of frying, such as continuous frying or batch frying of the snack pieces in a non-constrained mode, is also acceptable. For example, the pieces can be immersed in the frying fat on a moving belt or basket.

In a preferred embodiment of the present invention, the snack is fried in a blend of non-digestible fat and digestible fat. Preferably, the blend comprises from about 50% to about 90% non-digestible fat and from about 10% to about 50% digestible fat, and more preferably from about 70% to about 85% non-digestible fat and from about 15% to about 30% digestible fat. In an especially preferred embodiment, the snack fried in this blend comprises flavor enhancers, vitamin C, and the particulates of the present invention; this provides a snack with optimal flavor display and reduced waxiness impression.

Other ingredients known in the art can also be added to the edible fats and oils, including antioxidants such as TBHQ, tocopherols, ascorbic acid, chelating agents such as citric acid, and anti-foaming agents such as dimethylpolysiloxane.

The snack products made from this process typically have from about 20% to about 40%, and preferably from about 25% to about 35% total fat (i.e., combined non-digestible and digestible fat). If a higher fat level is desired in the snack product to further improve the flavor or lubricity of the snack, an oil, such as a triglyceride oil, can be sprayed onto the snack product when it emerges from the fryer, or when it is removed from the mold used in constrained frying. Oil can also be applied to the snack after baking. Preferably, the triglyceride oils applied have an iodine value greater than about 75, and most preferably above about 90. The oil can be used to increase the fat content of the snack to as high as 45% total fat. Thus, a snack product having various fat contents can be made using this additional step.

Triglyceride oils with characteristic flavor or highly unsaturated oils can be sprayed, tumbled or otherwise applied onto the snack product. Preferably triglyceride oils and non-digestible fats are used as a carrier to disperse flavors and are added topically to the snack product. These include, but are not limited to, butter flavored oils, natural or artificial flavored oils, herb oils, and oils with potato, garlic, or onion flavors added. This allows the introduction of a variety of flavors without having the flavor undergo browning reactions during the frying. This method can be used to introduce oils which would ordinarily undergo polymerization or oxidation during the heating necessary to fry the snacks.

### ANALYTICAL METHODS

WATER ACTIVITY

The method used to measure water activity is European COST-91 Study on Water Activity Measurements.

TOTAL FAT CONTENT

The method used to measure total fat content (both digestible and non-digestible) of the snack product herein is AOAC 935.39 (1997).

DIGESTIBLE FAT CONTENT

Digestible lipid (NLEA) method AOAC PVM 4:1995 is used to determine the digestible fat content of the snack product herein.

NON-DIGESTIBLE FAT CONTENT

Non-Digestible Fat Content=Total Fat Content—Digestible Fat Content

### EXAMPLES

The following examples are illustrative of the present invention, but are not meant to be limiting thereof.

EXAMPLE 1

The following composition is used to make fabricated potato chips. The dough composition comprises 30% water (based on the total dough composition), 3% emulsifier (mixture of 35% mono-glyceride/65% partially hydrogenated soybean oil) and 67% of the following mixture of ingredients:

| Ingredient | Wt. % |
|---|---|
| Potato flakes | 74.6 |
| Wheat Starch | 7.8 |
| Corn Flour | 8.8 |
| Maltodextrin | 6.9 |
| Potato peel | 0.4 |
| Wheat Bran | 1.5 |

A mix consisting of the dry ingredients, water and emulsifier are blended in a Turbulizer® to form a loose, dry dough (˜15 seconds). The maltodextrin may be dissolved in the water before addition to the Turbolizer®. The dough is sheeted by continuously feeding it through a pair of sheeting rolls forming an elastic continuous sheet without pin holes. Sheet thickness is controlled to 0.02 inches (0.05 cm). The front roll is heated to about 90° F. (32° C.) and the back roll is heated to about 135° F. (57° C.). The dough sheet is then cut into oval shaped pieces and fried in a constrained flying mold at 400° F. for about 10 seconds. The frying fat is a sunflower seed oil. The fried pieces contain about 33% fat. Oil spray is topically applied to increase total fat to 38%.

EXAMPLE 2

The following composition is used to make fabricated potato chips. The dough composition comprises 30% water (based on the total dough composition), 3% emulsifier (mixture of 35% mono-glyceride/65% partially hydrogenated soybean oil), and 67% of the following mixture of ingredients:

| Ingredient | Wt. % |
|---|---|
| Potato flakes | 74.5 |
| Wheat Starch | 7.7 |
| Corn Flour | 8.7 |
| Maltodextrin | 6.9 |
| Potato peel | 0.4 |
| Wheat Bran | 1.5 |
| Herb/Spice Mix | 0.3 |

The Herb/Spice Mix comprises a mixture of:

| Herb/Spice | Percentage in Mix, Wt. % |
|---|---|
| dried onion | 60% |
| garlic powder | 20% |
| black pepper | 10% |
| celery seed | 2% |
| Basil | 2% |
| Oregano | 2% |
| Savory | 2% |
| Coriander | 1% |
| Cumin | 1% |

The process set forth in Example 1 is used to make the fabricated potato chips.

EXAMPLE3

The following composition is used to make fabricated potato chips. The dough composition comprises 30% water (based on the total dough composition), 3% emulsifier (mixture of 35% mono-glyceride/65% partially hydrogenated soybean oil), and 67% of the following mixture of ingredients:

| Ingredient | Wt. % |
|---|---|
| Potato flakes | 73.2 |
| Wheat Starch | 7.3 |
| Corn Flour | 8.7 |
| Maltodextrin | 6.9 |
| Potato peel | 0.4 |
| Wheat Bran | 1.5 |
| Herb/Spice Mix | 2.0 |

The process set forth in Example 1 is used to make the fabricated potato chips.

EXAMPLE 4

The following composition is used to make fabricated potato chips. The dough composition comprises 30% water (based on the total dough composition), 3% emulsifier (mixture of 35% mono-glyceride/65% partially hydrogenated soybean oil), and 67% of the following mixture of ingredients:

| Ingredient | Wt. % |
|---|---|
| Potato flakes | 74.7 |
| Wheat Starch | 7.7 |
| Corn Flour | 8.7 |
| Maltodextrin | 6.9 |
| Potato peel | 0.4 |
| Wheat Bran | 1.5 |
| Fried Potato Flavor | 0.1 |

The Fried Potato Flavor (Firmenich #56.708/BH) can be mixed with the emulsifier first before its addition into the dough. The process set forth in Example 1 is used to make the fabricated potato chips.

EXAMPLE 5

The following composition is used to make fabricated potato chips. The dough composition comprises 33% water (based on the total dough composition), 3% emulsifier (mixture of 35% mono-glyceride/65% partially hydrogenated soybean oil), and 64% of the following mixture of ingredients:

| Ingredient | Wt. |
|---|---|
| Potato flakes | 72.1 |
| Ultra-Sperse ™ | 5.5 |
| Maltodextrin DE 18 | 5.5 |
| Potato Flanules | 13.8 |
| N Creamer 46 ™ | 0.9 |
| Wheat Bran | 1.6 |
| Potato Peel | 0.4 |
| Ascorbic Acid | 0.2 |

A mix consisting of the dry ingredients, water and emulsifier are blended in a Turbolizer® to form a loose, dry dough (˜15 seconds). The maltodextrin and ascorbic acid can be dissolved in the water before their addition to the Turbulizer®. The dough is sheeted by continuously feeding it through a pair of sheeting rolls forming an elastic continuous sheet without pin holes. Sheet thickness is controlled to 0.02 inches (0.05 cm). The front roll is heated to about 90° F. (32° C.) and the back roll is heated to about 135° F. (57° C.). The dough sheet is then cut into oval shaped pieces and fried in a constrained frying mold at 385° F. (196° C.) for about 10 seconds. The frying fat is a blend of 20% cottonseed oil and 80% OLEAN™ (made by The Procter and Gamble Company). The resulting product has a crisp texture. The chip is fortified by spraying with an OLEAN™ vitamin suspension containing vitamin A, D, E and K while the chips are still hot.

EXAMPLE 6

The following composition is used to make fabricated potato chips. The dough composition comprises 33% water (based on the total dough composition), 3% emulsifier (mixture of 35% mono-glyceride/65% partially hydrogenated soybean oil), and 64% of the following mixture of ingredients:

| Ingredient | Wt. |
|---|---|
| Potato flakes | 72.0 |
| Ultra-Sperse ™ | 5.5 |
| Maltodextrin DE 18 | 5.5 |
| Potato Flanules | 13.7 |
| N Creamer 46 ™ | 0.9 |
| Wheat Bran | 1.6 |
| Potato Peel | 0.4 |
| Ascorbic Acid | 0.2 |
| Herb/Spice Mix | 0.2 |

The process set forth in Example 5 is used to make the fabricated potato chips.

### EXAMPLE 7

The following composition is used to make fabricated potato chips. The dough composition comprises 33% water (based on the total dough composition), 3% emulsifier (mixture of 35% mono-glyceride/65% partially hydrogenated soybean oil), and 64% of the following mixture of ingredients:

| Ingredient | Wt. |
|---|---|
| Potato flakes | 70.8 |
| Ultra-Sperse ™ | 5.3 |
| Maltodextrin DE 18 | 5.3 |
| Potato Flanules | 13.5 |
| N Creamer 46 ™ | 0.9 |
| Wheat Bran | 1.6 |
| Potato Peel | 0.4 |
| Ascorbic Acid | 0.2 |
| Herb/Spice Mix | 2.0 |

The process set forth in Example 5 is used to make the fabricated potato chips.

EXAMPLE 8

The following composition is used to make fabricated potato chips. The dough composition comprises 33% water (based on the total dough composition), 3% emulsifier (mixture of 35% mono-glyceride/65% partially hydrogenated soybean oil), and 64% of the following mixture of ingredients:

| Ingredient | Wt. |
|---|---|
| Potato flakes | 72.0 |
| Ultra-Sperse ™ | 5.5 |
| Maltodextrin DE 18 | 5.5 |
| Potato Flanules | 13.6 |
| N Creamer 46 ™ | 0.9 |
| Wheat Bran | 1.6 |
| Potato Peel | 0.4 |
| Ascorbic Acid | 0.2 |
| Herb/Spice Mix | 0.2 |
| Fried Potato Flavor | 0.1 |

The Fried Potato Flavor (Firmenich #56.708/BH) can be mixed with the emulsifier first before its addition into the dough.

A mix consisting of the dry ingredients, water and emulsifier are blended in a Turbulizer® to form a loose, dry dough (˜15 seconds). The maltodextrin may be dissolved in the water before addition to the Turbolizer®. The dough is sheeted by continuously feeding it through a pair of sheeting rolls forming an elastic continuous sheet without pin holes. Sheet thickness is controlled to 0.02 inches (0.05 cm). The front roll is heated to about 90° F. (32° C.) and the back roll is heated to about 135° F. (57° C.). The dough sheet is then cut into oval shaped pieces and fried in a constrained frying mold at 400° F. for about 10 seconds. The frying fat is a 80% Olean™/20% sunflower seed oil blend. The fried pieces contain about 33% fat.

EXAMPLE 9

The following composition is used to make fabricated potato chips. The dough composition comprises about 30% water (based on the total dough composition), 3% emulsifier (mixture of 35% mono-glyceride/65% partially hydrogenated soybean oil) and 67% of the following mixture of ingredients:

| Ingredient | Wt. % |
|---|---|
| Potato flakes | 74.6 |
| Wheat Starch | 7.9 |
| Corn Flour | 8.8 |
| Maltodextrin | 6.9 |
| Potato peel | 0.4 |
| Wheat Bran | 1.4 |

A mix consisting of the dry ingredients, water and emulsifier are blended in a Turbulizer® to form a loose, dry dough (˜15 seconds). The maltodextrin may be dissolved in the water before addition to the Turbolizer®. The dough is sheeted by continuously feeding it through a pair of sheeting rolls forming an elastic continuous sheet without pin holes. Sheet thickness is controlled to 0.02 inches (0.05 cm). The front roll is heated to about 90° F. (32° C.) and the back roll is heated to about 135° F. (57° C.). The dough sheet is then cut into oval shaped pieces and fried in a constrained frying mold at 400° F. for about 10 seconds. The frying fat is a 80% Olean™/20% sunflower seed oil blend. The fried pieces contain about 33% fat.

### INCORPORATION BY REFERENCE

All of the aforementioned patents, publications, and other references are herein incorporated by reference in their entirety.

What is claimed is:

1. A dough for making fabricated snacks, wherein said dough comprises from about 0.1 ppt to about 6% of flavor enhancer.

2. The dough of claim 1, wherein said dough comprises from about 10 ppm to about 200 ppm of flavor enhancer.

3. The dough of claim 1, wherein said flavor enhancer is selected from the group consisting of amino acids, peptides, proteins, vitamins, reducing sugars, nucleotide flavor enhancers, carbohydrate decomposition products, extractives of herbs and spices, oleoresins, and mixtures thereof.

4. The dough of claim 3, additionally comprising from about 0.01% to about 0.4% Vitamin C.

5. The dough of claim 3, additionally comprising from about 0.05% to about 0.2% Vitamin C.

6. A snack produced from the dough of claim 1, 3, or 4, wherein said snack is fried in non-digestible fat, digestible fat, or a mixture thereof.

7. The snack of claim 6, wherein said snack is fried in a mixture of non-digestible and digestible fat comprising from about 50% to about 90% non-digestible fat and from about 10% to about 50% digestible fat.

8. The snack of claim 6, wherein said snack is fried in a mixture of non-digestible and digestible fat comprising from about 70% to about 85% non-digestible fat and from about 15% to about 30% digestible fat.

9. The dough of claim 1 or 4, further comprising from about 0.1% to about 10% particulates.

10. The dough of claim 1 or 4, further comprising up to about 8% herbs, spices, or a mixture thereof.

11. A snack produced from the dough of claim 9, wherein said particulates have a visual surface coverage of up to about 100% of the surface area of the snack.

12. A dough comprising particulates, wherein said particulates have:
(a) less than about 60% fat;
(b) a Water Activity of less than about 0.8; and
(c) a size such that they can pass though a U.S. mesh # of from about 5 to about 50.

13. A snack produced from the dough of claim 12.

14. The snack of claim 13, wherein said snack is fried in non-digestible fat, digestible fat, or a mixture thereof.
